(19) United States
(12) Patent Application Publication
(10) Pub. No.: US 2026/0148544 A1
(43) Pub. Date: May 28, 2026

(54) HIERARCHICAL INTERLACEMENT GRAPH APPROACH TO SCENE GRAPH GENERATION IN VIDEO UNDERSTANDING

(71) Applicant: BOARD OF TRUSTEES OF THE UNIVERSITY OF ARKANSAS, Little Rock, AR (US)

(72) Inventors: Khoa Luu, Fayetteville, AR (US); Trong-Thuan Nguyen, Fayetteville, AR (US); Anh Pha Nguyen, Fayetteville, AR (US)

(73) Assignee: BOARD OF TRUSTEES OF THE UNIVERSITY OF ARKANSAS, Little Rock, AR (US)

(21) Appl. No.: 19/403,072

(22) Filed: Nov. 27, 2025

Related U.S. Application Data
(60) Provisional application No. 63/726,199, filed on Nov. 27, 2024.

(51) Int. Cl. G06V 10/86; G06V 10/77; G06V 20/40

(52) U.S. Cl. CPC G06V 10/86; G06V 10/77; G06V 20/41

(57) ABSTRACT

Systems and methods for evaluating dynamic interactions of a video are disclosed. The method includes receiving a video having a plurality of clips and deconstructing each clip of the plurality of clips into a graph having a plurality of nodes and a plurality of edges. Each node of the plurality of nodes in the graph represents a subject or an object and each edge of the plurality of edges in the graph represents an interactivity between two nodes. The method further includes tracking changes in node-node interactivities in different clips to evaluate the dynamic interactions of the video.

### CROSS-REFERENCE TO RELATES APPLICATIONS

This patent application claims priority from, and incorporates by reference the entire disclosure of, U.S. Provisional Patent Application No. 63/726,199 filed on Nov. 27, 2024.

### TECHNICAL FIELD

The present disclosure relates generally to video understanding and more particularly, but not by way of limitation, to a hierarchical interlacement graph approach to scene graph generation in video understanding.

### BACKGROUND

This section provides background information to facilitate a better understanding of the various aspects of the disclosure. The statements in this section of this document are to be read in this light, and not as admissions of prior art.

Visual interactivity understanding within visual scenes presents a significant challenge in computer vision. Existing methods focus on complex interactivities while leveraging a simple relationship model. These methods, however, struggle with a diversity of appearance, situation, position, interaction, and relation in videos. This limitation hinders the ability to fully comprehend the interplay within the complex visual dynamics of subjects.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a method of evaluating dynamic interactions of a video. In some embodiments, the method includes receiving a video having a plurality of clips and deconstructing each clip of the plurality of clips into a graph having a plurality of nodes and a plurality of edges. In some embodiments, each node of the plurality of nodes in the graph represents a subject or an object. In some embodiments, each edge of the plurality of edges in the graph represents an interactivity between two nodes. In some embodiments, the method further includes tracking changes in node-node interactivities in different clips to evaluate the dynamic interactions of the video.

In another embodiment, the present disclosure pertains to a system for evaluating dynamic interactions of a video. In some embodiments, the system includes memory and at least one processor coupled to the memory and configured to implement a method. In some embodiments, the method includes receiving a video having a plurality of clips and deconstructing each clip of the plurality of clips into a graph having a plurality of nodes and a plurality of edges. In some embodiments, each node of the plurality of nodes in the graph represents a subject or an object. In some embodiments, each edge of the plurality of edges in the graph represents an interactivity between two nodes. In some embodiments, the method further includes tracking changes in node-node interactivities in different clips to evaluate the dynamic interactions of the video.

In a further embodiment, the present disclosure pertains to a computer-program product having a non-transitory computer-usable medium having computer-readable program code embodied therein. In some embodiments, the computer-readable program code is adapted to be executed to implement a method for evaluating dynamic interactions of a video. In some embodiments, the method includes receiving a video having a plurality of clips and deconstructing each clip of the plurality of clips into a graph having a plurality of nodes and a plurality of edges. In some embodiments, each node of the plurality of nodes in the graph represents a subject or an object. In some embodiments, each edge of the plurality of edges in the graph represents an interactivity between two nodes. In some embodiments, the method further includes tracking changes in node-node interactivities in different clips to evaluate the dynamic interactions of the video.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1A illustrates a method of evaluating dynamic interactions of a video in accordance with various embodiments of the present disclosure.

FIG. 1B illustrates a system of evaluating dynamic interactions of a video in accordance with various embodiments of the present disclosure.

FIG. 2 illustrates an example from the Appearance-Situation-Position-Interaction-Relation (ASPIRe) dataset for Visual Interactivity Understanding. The top row shows keyframes with the bounding boxes. Appearance, Situation, Position, Interaction, and Relation are attributes presented in the dataset.

FIGS. 3A-C illustrate an example and annotations in the ASPIRe dataset of an image (FIG. 3A), with FIG. 3B showing a graph representation of the attributes in the figure, and FIG. 3C showing a summary of annotated double-actor attributes between two actors in the ASPIRe dataset. Appearance and situation are single-actor attributes.

FIGS. 4A-4B illustrate statistics from the proposed ASPIRe dataset showing (FIG. 4A) video sources and (FIG. 4B) interactivity types.

FIGS. 5A-5B illustrate the terminologies used in the proposed ASPIRe dataset and Hierarchical Interlacement Graph (HIG) with FIG. 5A showing interactivities, FIG. 5B(i) showing double-actor interlacements, and FIG. 5B(ii) showing single-actor interlacements.

FIG. 6 illustrates the proposed HIG. The highlighted attributes denote the temporal changes in the graph. Then, all predicted interactivities are accumulated into the next hierarchy level. A higher-level graph cell covers a bigger portion of video frames.

FIG. 7 illustrates qualitative results of position, interaction, and relation from scene graphs generated from the HIG model.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Recent advancements in deep learning techniques have significantly enhanced comprehension of visual interactions and relationships across diverse contexts, ranging from fundamental tasks, such as action recognition and video captioning, to more intricate applications like spatio-temporal detection and video grounding. However, existing methodologies often need help to fully encapsulate the extensive spectrum of visual relationships due to their dependence on predefined categories and linear interpretation of visual sequences.

To address this limitation, the present disclosure introduces the Appearance-Situation-Position-Interaction-Relation (ASPIRe) dataset, which substantially expands the typology of interactivity represented, and the Hierarchical Interlacement Graph (HIG) model, a novel framework designed to understand temporal interactivities. HIG operates with a unique unified layer at every level to jointly process interactivities, simplifying operations and eliminating the intricacies of multilayer architectures. Rather than perceiving video content as a monolithic block, HIG models an input video with a hierarchical structure, promoting a holistic understanding of object interplays. In contrast to established benchmarks that focus on isolated aspects, the HIG model facilitates a more comprehensive and integrated understanding of visual content, constituting a significant step forward in uncovering the complex interactivities present in real-world environments.

The ASPIRe dataset encompasses five interactivity types, including appearance, situation, position, interaction, and relationship, observed among subjects in video content. It precisely categorizes these interactivities into single-actor attributes (appearance and situation) and double-actor attributes (position, interaction, and relationship), offering an in-depth exploration of object interactivities over time. To solve the visual interactivity understanding on the ASPIRe dataset, the HIG approach is designed to analyze and predict the intricate dynamics of interactivity among subjects within videos. This model distinguishes itself through its unique hierarchical structure that methodically processes and refines interactivity data across multiple layers, capturing the essence of spatial and temporal interactivities. In particular, the HIG approach employs a message-passing mechanism to facilitate node interactivities, dynamically updating each node's feature vector based on neighboring node attributes. This process ensures a comprehensive representation of interactivities, enabling the model to identify the most appropriate interactivities between subjects accurately. The training process of the HIG model is meticulously engineered for optimal performance, incorporating a hierarchical weight-sharing approach and sequential unfreezing to refine feature embeddings progressively.

At the core of the HIG model, it represents a video as a series of interconnected graphs, each corresponding to specific pairs of frames. Nodes within these graphs symbolize the subjects in the video, while edges represent their dynamic interactivities. This graph-based approach allows for an intuitive and effective mapping of complex interactivity patterns that unfold over time. A pivotal mechanism within the HIG model is its utilization of message-passing, a process through which nodes exchange information regarding their state and the nature of their interactivities. This mechanism is crucial for the dynamic updating of feature vectors associated with each node. By incorporating information from adjacent nodes, the model ensures a continuously evolving and enriching representation of each subject's role and relationships within the video. As the model traverses its hierarchical levels, it aggregates these feature vectors from lower-level graphs to form higher-level representations. This aggregation process is critical to the model's synthesizing a detailed understanding of interlacements. Upon reaching the apex of the hierarchy, the HIG model has consolidated the data into a singular, all-encompassing graph that encapsulates the full spectrum of interactivity within the video.

The combination of the ASPIRe dataset and the HIG model advances the field of computer vision, offering a more nuanced understanding of how humans interact with their surroundings and each other, with far-reaching implications for a wide range of applications, from enhancing video surveillance systems to improving interfaces for human-computer interaction, enabling researchers and developers to create more sophisticated and context-aware systems that better understand and respond to human behavior in real-world scenarios.

### Methods and Systems for Evaluating Dynamic Interactions in a Video

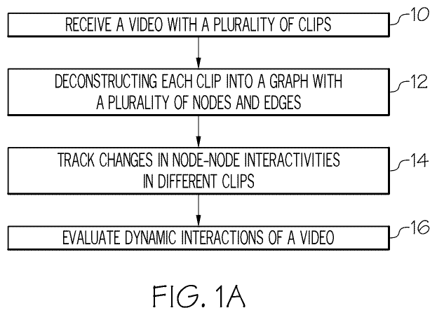

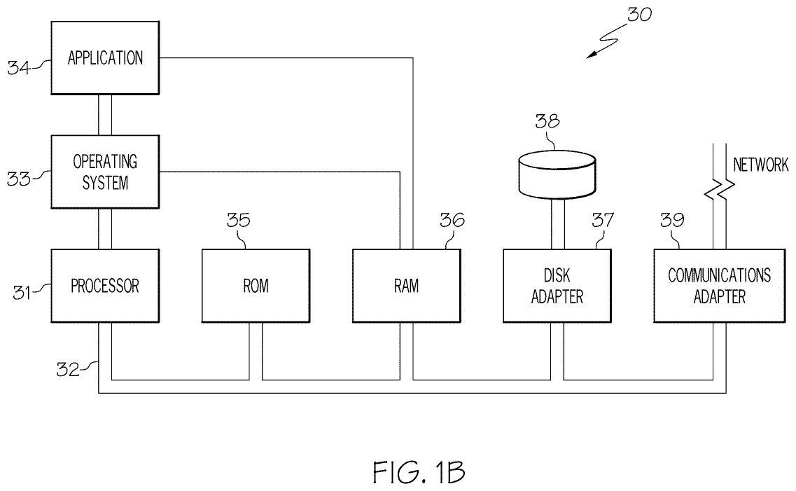

In view of the aforementioned, in some embodiments, the present disclosure pertains to methods of evaluating dynamic interactions of a video. In some embodiments illustrated in FIG. 1A, the methods of the present disclosure include: receiving a video with a plurality of clips (step 10); deconstructing each clip into a graph with a plurality of nodes and edges, where each node in the graph represents a subject or an object, and where each edge in the graph represents an interactivity between two nodes (step 12); and tracking changes in node-node interactivities in different clips (step 14) to evaluate the dynamic interactions of the video (step 16).

Additional embodiments of the present disclosure pertain to systems for evaluating dynamic interactions of a video. In systems include memory and at least one processor coupled to the memory and configured to implement a method. In some embodiments, the method includes: (1) receiving a video with a plurality of clips; (2) deconstructing each clip into a graph with a plurality of nodes and edges, where each node in the graph represents a subject or an object, and where each edge in the graph represents an interactivity between two nodes; and (3) tracking changes in node-node interactivities in different clips to evaluate the dynamic interactions of the video.

Further embodiments of the present disclosure pertain to computer-program products with non-transitory computer-usable mediums having computer-readable program code embodied therein. In some embodiments, the computer-readable program code is adapted to be executed to implement a method for evaluating dynamic interactions of a video. In some embodiments, the methods include one or more methods as disclosed herein.

The methods and systems of the present disclosure can be utilized to track changes in various node-node interactivities. For instance, in some embodiments, the interactivities include single-actor attributes of subjects, double-actor attributes of subjects, subject-subject interactions, subject-object interactions, object-object interactions, or combinations thereof.

In some embodiments, the interactivities include single-actor attributes of subjects. In some embodiments, the single-actor attributes include appearance, situation, or combinations thereof.

In some embodiments, the interactivities include double-actor attributes of subjects. In some embodiments, the double-actor attributes include position, interaction, relationship, or combinations thereof.

The methods and systems of the present disclosure may be utilized to track changes in node-node interactivities in various manners. For instance, in some embodiments, tracking changes in node-node interactivities include dynamically updating each node's feature vector based on neighboring node attributes. In some embodiments, the methods and systems of the present disclosure also include a step of aggregating feature vectors from lower-level graphs to form higher-level representations. In some embodiments, the higher-level representation encapsulates the full spectrum of interactivity within the video.

Additionally, the systems of the present disclosure may have various architectures and forms. For instance, in some embodiments, the systems of the present disclosure are in the form of a web-based program, an application-based program, or combinations thereof. In some embodiments, the systems of the present disclosure include a machine-learning algorithm or artificial intelligence algorithm. In some embodiments, the machine learning algorithm or artificial intelligence algorithm is trained on the video clips.

The systems of the present disclosure can include various types of computer-readable storage mediums. For instance, in some embodiments, the computer-readable storage medium can be a tangible device that can retain and store instructions for use by an instruction execution device. In some embodiments, the computer-readable storage medium may include, without limitation, an electronic storage device, a magnetic storage device, an optical storage device, an electromagnetic storage device, a semiconductor storage device, or combinations thereof. A non-exhaustive list of more specific examples of suitable computer-readable storage medium includes, without limitation, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, or combinations thereof.

A computer-readable storage medium, as used herein, is not to be construed as being transitory signals per se. Such transitory signals may be represented by radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer-readable program instructions for systems can be downloaded to respective computing/processing devices from a computer-readable storage medium or to an external computer or external storage device via a network, such as the Internet, a local area network (LAN), a wide area network (WAN) and/or a wireless network. In some embodiments, the network may include copper transmission cables, optical transmission fibers, wireless transmission, routers, firewalls, switches, gateway computers and/or edge servers. In some embodiments, a network adapter card or network interface in each computing/processing device receives computer-readable program instructions from the network and forwards the computer-readable program instructions for storage in a computer-readable storage medium within the respective computing/processing device.

In some embodiments, computer-readable program instructions for carrying out operations of the present disclosure may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

In some embodiments, the computer-readable program instructions may execute entirely on the user's computer, partly on the user's computer, as a stand-alone software package, partly on the user's computer and partly on a remote computer or entirely on the remote computer or server. In the latter scenario, the remote computer may be connected in some embodiments to the user's computer through any type of network, including a LAN or a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry in order to perform aspects of the present disclosure.

Embodiments of the present disclosure for evaluating dynamic interactions of a video as discussed herein may be implemented using a system illustrated in FIG. 1B. Referring now to FIG. 1B, FIG. 1B illustrates an embodiment of the present disclosure of the hardware configuration of a system 30 which is representative of a hardware environment for practicing various embodiments of the present disclosure.

System 30 has a processor 31 connected to various other components by system bus 32. An operating system 33 runs on processor 31 and provides control and coordinates the functions of the various components of FIG. 1B. An application 34 in accordance with the principles of the present disclosure runs in conjunction with operating system 33 and provides calls to operating system 33, where the calls implement the various functions or services to be performed by application 34. Application 34 may include, for example, a program for evaluating dynamic interactions of a video as discussed in the present disclosure, such as in connection with FIG. 1A.

Referring again to FIG. 1B, read-only memory (“ROM”) 35 is connected to system bus 32 and includes a basic input/output system (“BIOS”) that controls certain basic functions of system 30. Random access memory (“RAM”) 36 and disk adapter 37 are also connected to system bus 32. It should be noted that software components including operating system 33 and application 34 may be loaded into RAM 36, which may be system's 30 main memory for execution. Disk adapter 37 may be an integrated drive electronics (“IDE”) adapter that communicates with a disk unit 38 (e.g., a disk drive). It is noted that the program for evaluating dynamic interactions of a video, as discussed in the present disclosure, such as in connection with FIG. 1A, may reside in disk unit 38 or in application 34.

System 30 may further include a communications adapter 39 connected to system bus 32. Communications adapter 39 interconnects system bus 32 with an outside network (e.g., wide area network) to communicate with other devices.

Aspects of the present invention are described herein with reference to flowchart illustrations and/or block diagrams of methods, apparatus (systems), and systems according to embodiments of the invention. It will be understood that each block of the flowchart illustrations and/or block diagrams and combinations of blocks in the flowchart illustrations and/or block diagrams can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks. The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and systems according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Applications and Advantages

The ASPIRe dataset and Hierarchical Interlacement Graph (HIG) model offer significant advantages that contribute to the advancement of computer vision research. Firstly, these innovations provide a richer understanding of complex interactions by capturing various interactivity types and their intricate relationships. Secondly, the detailed temporal annotations within the ASPIRe dataset enable fine-grained analysis of how interactions evolve. Thirdly, the structured hierarchical analysis framework of the HIG model allows for a systematic and comprehensive examination of interactivities at multiple levels of granularity. Moreover, the HIG model's ability to provide insights into the dynamics of interactions over time facilitates the study of how relationships between subjects change and develop throughout a video sequence. Lastly, the versatile nature of these innovations makes them applicable across various fields, including human computer interaction and autonomous systems. By offering a solid foundation for future research in computer vision, the ASPIRe dataset and HIG model significantly enhance the capability of systems to interpret and respond to human behaviors and interactivities accurately.

### ADDITIONAL EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. HIG: Hierarchical Interlacement Graph Approach to Scene Graph Generation in Video Understanding

Visual interactivity understanding within visual scenes presents a significant challenge in computer vision. Existing methods focus on complex interactivities while leveraging a simple relationship model. These methods, however, struggle with a diversity of appearance, situation, position, interaction, and relation in videos. This limitation hinders the ability to fully comprehend the interplay within the complex visual dynamics of subjects. In this Example, Applicant delves into interactivities understanding within visual content by deriving scene graph representations from dense interactivities among humans and objects. To achieve this goal, Applicant first presents a new dataset containing Appearance-Situation-Position-Interaction-Relation predicates, named ASPIRe, offering an extensive collection of videos marked by a wide range of interactivities. Then, Applicant proposes a new approach named Hierarchical Interlacement Graph (HIG), which leverages a unified layer and graph within a hierarchical structure to provide deep insights into scene changes across five distinct tasks. This approach demonstrates superior performance to other methods through extensive experiments conducted in various scenarios.

### Example 1.1. Introduction

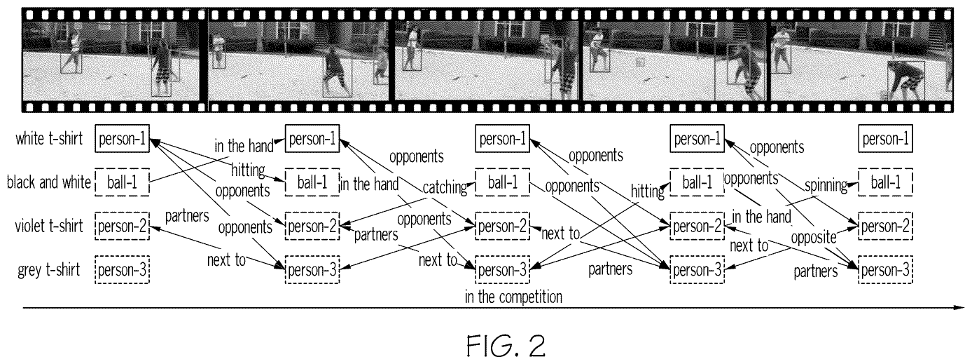

Visual interaction and relationship understanding have witnessed significant advancements in computer vision in recent years. Various methods, including deep learning, have been introduced, particularly in achieving advanced comprehension of diverse relationships for a holistic visual understanding. Traditional methods span from action recognition and localization to intricate processes like video captioning, spatio-temporal detection and video grounding. However, these tasks often interpret visual temporal sequences in a constrained, uni-dimensional way. In addition, relation modeling techniques, including scene graph generation and visual relationship detection, adhere to predefined relation categories, limiting the scope for discovering more diverse relationships. Delving into the Visual Interactivity Understanding problem (FIG. 2), Applicant introduces a new dataset, characterized by 5× larger interactivity types, including Appearance-Situation-Position-Interaction-Relation, named ASPIRe. To this end, Applicant introduces the Hierarchical Interlacement Graph (HIG), a novel approach to the Interactivity Understanding problem. The proposed HIG framework integrates the evolution of interactivities over time. It presents an intuitive modeling technique and lays the groundwork for enriched comprehension of visual activities and complex interactivities. HIG operates with a unique unified layer at every level to jointly process interactivities. This strategy simplifies operations and eliminates the intricacies of multilayers. Instead of perceiving video content as a monolithic block, HIG models an input video with a hierarchical structure, promoting a holistic grasp of object interplays. Each level delves into essence insights, leveraging the strengths of different levels to capture scene changes over time.

In addition, the proposed HIG framework promotes dynamic adaptability and flexibility, empowering the model to adjust its structure and functions to capture the interactivities throughout video sequences. This adaptability is further showcased as the HIG framework proficiently tackles five distinct tasks, demonstrating its extensive flexibility in decoding various interactivity nuances. The proposed HIG framework is not confined to specific tasks or domains, emphasizing its broad applicability and potential.

The Contributions of this Example. There are three main contributions to this Example. First, Applicant develops a new dataset named ASPIRe for the Visual Interactivity Understanding problem, augmented with numerous predicate types to capture the complex interplay in the real world. Second, Applicant proposes the Hierarchical Interlacement Graph (HIG), standing out with its hierarchical graph structure and unified layer to ensure scalability and flexibility, comprehensively capturing intricate interactivities within video content. Finally, comprehensive experiments, including evaluating other methods on the APSIRe dataset and HIG model on both video and image datasets, Applicant proves the advantages of the proposed approach that achieves State-of-the-Art (SOTA) results.

### Example 1.2. Related Work

Dataset and Benchmarks. Dataset: Action Genome introduces a comprehensive video database with action and spatiotemporal scene graph annotations. VidOR and EPIC-KITCHENS focus on object and relationship detection and egocentric action recognition. Ego4D, VidSTG, and PVSG further enrich scene understanding and video scene graph resources. These datasets provide benchmarks for evaluating scene understanding, detailed in Table 1.

TABLE 1
Comparison of available datasets. # denotes the number of the corresponding item. The top sub-block of the table
is the summary of image datasets, and the bottom is video datasets. Single and Double are the attribute types as defined
herein. H-H, H-O, O-O indicate the interactivity between Human and Human, Human and Object, Object and Object.

| | | | | | | | | | Attributes | | | |
|---|---|---|---|---|---|---|---|---|---|---|---|---|
| | | | | | | Annotations | | | | Double | | |
| Datasets | #Videos | #Frames | #Subjects | #ReICIs | #Settings | BBox | Mask | #Annotations | Single | H-H | H-O | O-O |
| Visual Genome | — | 108K | 33K | 42K | 1 | ✓ | X | 3.8M | X | X | ✓ | ✓ |
| PSG | — | 49K | 80 | 56 | 1 | ✓ | ✓ | 538.2K | X | ✓ | ✓ | ✓ |
| VidOR | 10K | — | 80 | 50 | 1 | ✓ | X | 50K | X | ✓ | ✓ | ✓ |
| Action Genome | 10K | 234K | 25 | 25 | 1 | ✓ | X | 476.3K | X | X | ✓ | X |
| VidSTG | 10K | — | 80 | 50 | 1 | ✓ | X | 50K | X | ✓ | ✓ | ✓ |
| EPIC- | 700 | 11.5K | 21 | 13 | 1 | ✓ | X | 454.3K | X | X | ✓ | X |
| KITCHENS | | | | | | | | | | | | |
| PVSG | 400 | 153K | 126 | 57 | 1 | ✓ | ✓ | — | X | ✓ | ✓ | ✓ |
| ASPIRe | 1.5K | 1.6M | 833 | 4.5K | 5 | ✓ | ✓ | 167.8K | ✓ | ✓ | ✓ | ✓ |

Benchmarks: Current benchmarks primarily rely on relation classification for identifying inter-object associations. Action Genome integrates spatiotemporal to Visual Genome to establish scene graphs with action recognition using SGFB. VidOR provides 10K videos for benchmarking video object detection and visual relation detection. EPIC-KITCHENS-100 offers a varied dataset with 100 hours of video, 20M frames, and 90K actions. Ego4D focuses on first-person video data, addressing past, present, and future aspects across nearly 3.6K videos. VidSTG introduces the Video Grounding for Multi-Form Sentences (STVG) task, augmenting VidOR with additional sentence annotations. Recently, PVSG expanded PSG, advancing video graph generation.

Interactivity Modeling Approaches. Video Situation Recognition: The VidSitu benchmark provides a collection of events and situations for evaluation, covering verb prediction, semantic role prediction, and event relations prediction. In a related approach within this benchmark, VideoWhisperer adopts a global perspective for video comprehension, utilizing self-attention across all video clips. Furthermore, the LVU benchmark is tailored for self-supervised video representation learning, with a strong focus on hierarchical methodologies.

Video Understanding: This contains a wide range of tasks and research efforts. Action recognition has advanced significantly through graph-based, few-shot learning, and transformer-based approaches. Another area of interest is object retrieval, object tracking, spatio-temporal detection, temporal audio-visual relationships which involves object detection/segmentation, relation detection and moment retrieval in video content. Additionally, there are challenges such as visual question answering and video captioning. Recently, video grounding has provided activities through natural language in visual content.

Scene Graph Generation: A Bayesian strategy for debiasing scene graphs in images has been introduced, enhancing recall without retraining. PE-Net leveraging prototype alignment to improve entity-predicate matching in a unified embedding space, incorporating novel learning and regularization to reduce semantic ambiguity. PS-GTR and PSGFormer introduce recent innovations in scene graph generation, which utilizes a transformer encoder-decoder to implicitly model scene graph triplets. Recently, PSG4DFormer has been proposed to predict segmentation masks and then track them to create associated scene graphs through a relational component.

For dynamic scenes, TEMPURA utilizes temporal consistency and memory-guided training to enhance the detection of infrequent visual relationships in videos. Researchers have introduced the Davidsonian Scene Graph (DSG) for assessing text-to-image alignment, operating a VQA module to process atomic propositions from text prompts and quantifying the alignment between text and image. Further, advancements have adapted scene graph techniques to video, focusing on temporal relationships and advancing comprehensive scene understanding.

Limitations of Prior Datasets. Existing datasets exhibit notable limitations that hinder a comprehensive understanding of interactivity within visual content. Many of these datasets primarily focus on a limited set of interactivity types, overlooking the complexity of real-world interactions. This restricted scope has impeded the development of models capable of handling a variety of interactivities, thereby limiting their applicability to diverse scenarios. Moreover, previous datasets predominantly emphasize relationships within single connected components of the relational graph, neglecting complex scenes. Sparse annotations in some datasets further constrain relationship modeling, often failing to provide comprehensive coverage and potentially leading to model bias.

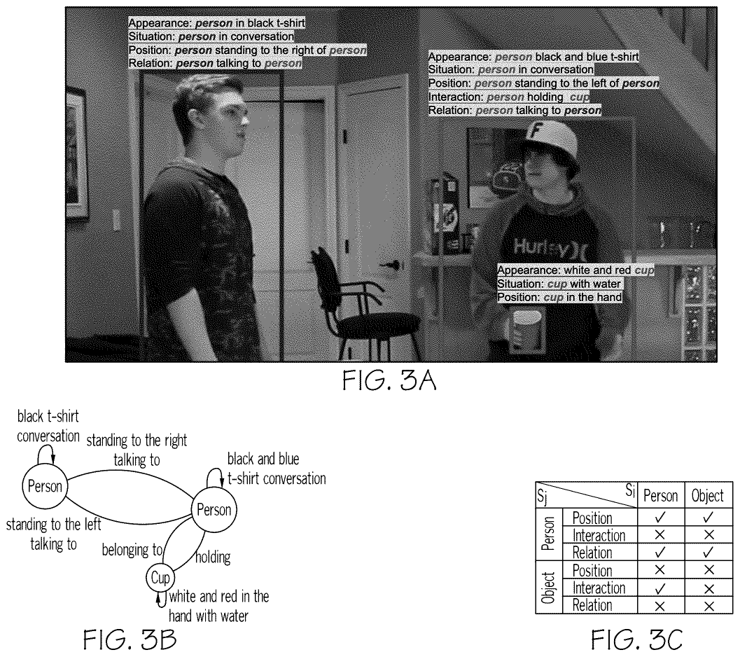

To address these limitations, Applicant introduces the new ASPIRe dataset to Visual Interactivity Understanding. The diversity of the ASPIRe dataset is showcased through its wide range of scenes and settings, distributed in seven scenarios. Therefore, ASPIRe distinguishes itself from earlier datasets, including five types of interactivity, as in FIGS. 3A-3C.

### Example 1.3. Dataset Overview

Dataset Collection and Annotation. Applicant introduced a dataset compiled from seven distinct sources, each contributing unique perspectives to the collection. The ArgoVerse and BDD datasets focus on outdoor driving scenes, providing valuable insights into real-world traffic scenarios. In contrast, the LaSOT and YFCC100M datasets comprise in-the-wild videos, capturing a diverse spectrum of human experiences and online interactions. Additionally, the dataset incorporates content from the AVA, Charades, and HACS datasets, encompassing videos that depict various human interactions, including interactions between humans and objects. This compilation results in a diverse scene featuring 833 objects. Therefore, the ASPIRe dataset enhances the understanding of activities, surpassing traditional image datasets like Visual Genome and PSG by integrating video data. This integration brings a dynamic dimension to scene analysis that is conspicuously absent in static datasets. ASPIRe stands out for its exceptional detail, demonstrating the dynamic interactivities over time. ASPIRe has a depth of interactivities context that is notably comprehensive of other datasets while only presenting the relationship of humans, including VidOR, Action Genome and PVSG, marking a considerable stride in the scene understanding.

To this end, Applicant introduces a structured annotation file anchored by a primary key named data. This file assembles dictionaries associated with a particular frame and detailed annotations. Each dictionary contains two lists: segments_info and annotations. The segments_info list is a collection of dictionaries that describe the individual segments of the image, and the annotations list comprises dictionaries that offer bounding boxes and masking details for each segment. Additionally, objects identified within these segments and annotations are assigned the track_id to maintain the identity within a video. In particular, the annotations within the ASPIRe dataset are distinguished by five interactivity descriptors: (i) appearances details visual traits of subjects or objects; (ii) situations describes the environmental context; (iii) positions identifies the location and orientation; (iv) interactions captures the dynamic actions between Human-Object; (v) relations define the connections and associations between Human-Human.

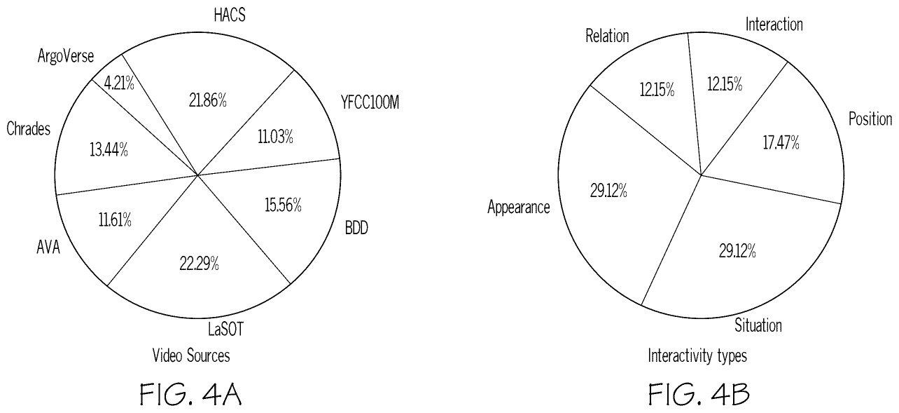

Dataset Statistics. The ASPIRe dataset is quantitatively analyzed in Table 1 and visually represented in FIGS. 4A-4B. ASPIRe contains 1,488 videos covering 833 object categories and 4,549 interactivities, including appearances, situations, positions, interactions, and relationships. The dataset is especially remarkable for its videos that depict a comprehensive and intricate variety of interactivities among subjects, with the number of appearances recorded at 722, situations at 2,902, positions at 130, interactions at 565, and relations at 230. Furthermore, the dataset features objects annotated with boxes and masks, amounting to 167,751 detail annotations.

Applicant provides a detailed analysis of average occurrences within each video of the ASPIRe dataset. On average, subjects are featured at 4.5 per video, showcasing diversity in the presence of objects. Both the frequency of appearances and situations remain steady at an average of 4.5 occurrences per video, suggesting a uniform representation of visual elements and their contextual narratives. Positions have a marginally lower average of 4.3 per video. Interactions and relationships averaged around 4.0 instances per video.

### Example 1.4. Methodology

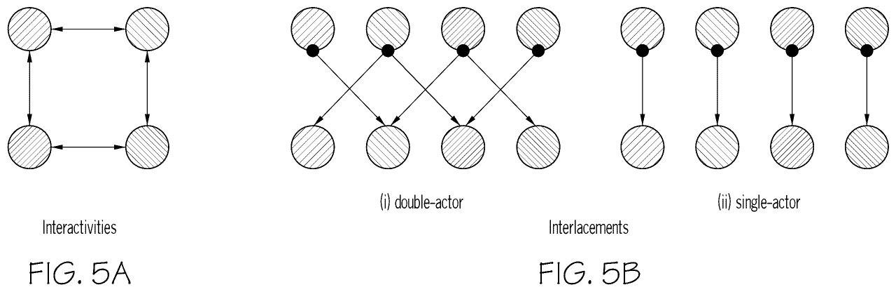

Terminologies. FIGS. 5A-5B illustrate the definitions for analyzing interactivities temporally. FIG. 5A shows the original definition of interactivities within the subjects as annotated in the proposed ASPIRe dataset. Interactivities refer to the relationship between subjects. FIG. 5B illustrates a new term Interlacements, which are interactivities that span across two or sets of nodes in time or frames. Interlacements is the novel design representing how the interactivities evolve in the proposed HIG model. FIG. 5B has two parts, including double-actor and single-actor attribute interlacements. FIG. 5B(i) defines double-actor attributes. Double-actor attributes include position, interaction, and relation, which are attributes that involve two subjects. FIG. 5B(ii) defines single-actor attributes. Single-actor attributes include appearance and situation, attributes of individual subjects.

Problem Formulation. Given a video input∈ [symbol] consisting of T frames and frame size of H×W, Applicant identified a set of distinct subjects, represented as vertices in the graph, Vₜ={Sᵢ}ₜ at a particular time t and an interactivity set I as in Eqn. (1).

$$I ( {S}_{i} , {S}_{j} ) = \{ A ( {S}_{i} ) , S ( {S}_{i} ) , 𝒫𝒪 ( {S}_{i} , {S}_{j} ) , ( {S}_{i} , {S}_{j} ) , ℛℰ ( {S}_{i} , {S}_{j} ) \} \qquad ( 1 )$$

It encapsulates all possible interactivities between subjects. Each element in I provides a fine-grain classification of the interactivity types. These interactivities are appearance A(Sᵢ), situation S(Sᵢ) to express the single-actor attributes, and position [symbol] (Sᵢ,Sⱼ), interaction [symbol] (Sᵢ,Sⱼ) and relation [symbol] (Sᵢ,Sⱼ) give the double-actor attributes, respectively. The primary objective is to construct a function ƒ. For each pair of subjects and each frame in the video, ƒ identifies the most fitting interactivities from the set I. This function is represented in Eqn. (2).

$$f : {V}_{t} \times {V}_{t} \to I \qquad ( 2 )$$

For every pair of objects drawn from Vₜ, the function ƒ learns to predict an interactivity set I, defining the Visual Interactivity Understanding task.

### Example 1.5. Proposed Method

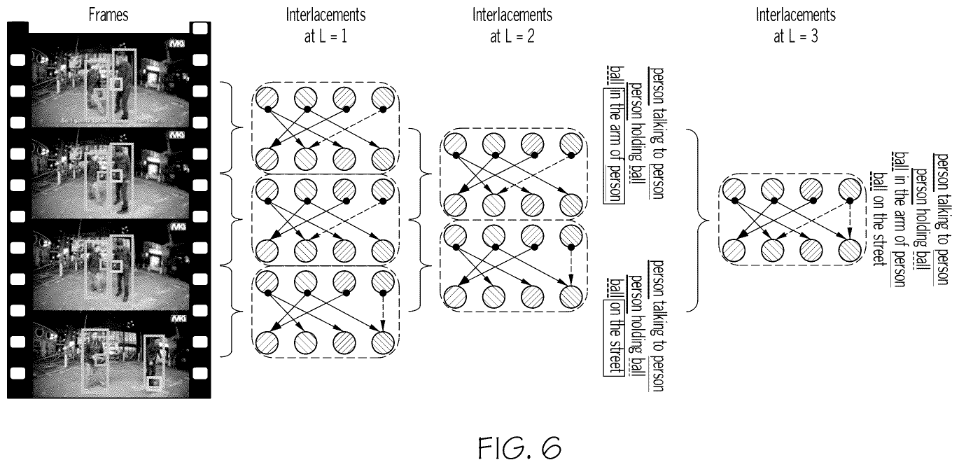

Eqn. (2) is the primary objective in this problem. The design of the graph structure, as in FIG. 6, will be described below.

Hierarchical Interlacement Graph (HIG). HIG model is designed to capture the complex dynamics of object interactivity across both spatial and temporal dimensions. It represents a video as a sequence of graphs

$${\{ {G}_{t} ( {V}_{t} , {E}_{t} ) \}}_{t = 1}^{T}$$

at the first layer, where each graph Gₜ corresponds to a pair of frames. Here, Vₜ denotes the set of nodes, and Eₜ represents the set of edges at time t. As the model progresses through subsequent layers, it combines graphs from the previous layer to form new, more comprehensive graphs, culminating in a single graph cell at the highest level L, representing the entire video interlacement.

HIG Blocks: The HIG model comprises HIG blocks, each representing a distinct level of interactivity within the hierarchical structure. These blocks function consistently across all levels l∈{1, . . . , L}. At each level l, the model integrates graphs from the previous level to enhance the understanding of interactivity across spatial and temporal dimensions, as detailed in Algorithm 1.

Algorithm 1. HIG Construction and Feature Embedding.

```
*  $Input : Frames as graphs {\{ {G}_{t} ( {V}_{t} , {E}_{t} ) \}}_{t = 1}^{T} ; initial features {ℱ}_{t}^{( 0 )} ( {S}_{i} )$
  $for each node {S}_{i} ; number of hierarchial levels L ; weight matrices {𝒲}_{ij}^{( l )}$
  for all levels l ∈ {1, . . . , L} and node pairs Sᵢ, Sⱼ ∈ Vₜ.
* Output: I(Sᵢ, Sⱼ)
  1: for l = 1 to L do
  2: Tₗ ← T − l + 1
  3: for t = 1 to Tₗ do
  4: G_{l,t}(V_{l,t}, E_{l,t}) ← ConstructGraph(Gₜ, l)
  5: for Sᵢ ∈ V_{l,t} do
  6:  ${m}_{t}^{( l )} ( {S}_{i} , {S}_{j} ) ← {𝒲}_{ij}^{( l )} \cdot {ℱ}_{t}^{( l - 1 )} ( {S}_{j} ) , ∀ {S}_{j} ∈ 𝒩 ( {S}_{i} )$
  7:  ${ℱ}_{t}^{( l )} ( {S}_{i} ) ← {\sum }_{t = 1}^{{T}_{l}} {ℱ}_{t}^{( l - 1 )} ( {S}_{j} ) , ∀ {S}_{j} ∈ 𝒩 ( {S}_{i} )$
  8: end for
  9: end for
10: end for
11:  $( {V}_{t}^{′} , {E}_{t}^{′} ) ← ( {V}_{L , {T}_{L}}^{′} , {E}_{L , {T}_{L}}^{′} )$
12:  ${\{ {ℱ}_{t}^{′} ( {S}_{i} ) \}}_{{S}_{i} ∈ {V}_{t}^{′}} ← {\{ {ℱ}_{L , {T}_{L}}^{′} ( {S}_{i} ) \}}_{{S}_{i} ∈ {V}_{L , {T}_{L}}^{′}}$
13:  $for ( {S}_{i} , {S}_{j} ) ∈ {V}_{t}^{′} \times {V}_{t}^{′} do$
14:  $I ( {S}_{i} , {S}_{j} ) ← 𝒞 ( {m}_{1}^{( L )} ( {S}_{i} , {S}_{j} ) , {ℱ}_{1}^{( L )} ( {S}_{i} ) )$
15: end for
```

The feature representation

$${F}_{t}^{( l )} ( {S}_{i} )$$

is dynamically updated for every node Sᵢ at each level l and time frame t. This update involves transformations and aggregations of information from the neighboring nodes of Sᵢ. Each node Sᵢ in the graph encapsulates a feature set that evolves through the hierarchical levels, progressing horizontally across levels and vertically across time frames, starting from t=1 to Tₗ=T−l+1 at each level. Specifically, at each level, the model transitions from processing a larger number of simpler graphs to fewer, more complex graphs. The feature representation

$${F}_{t}^{( l )} ( {S}_{i} )$$

at level l, with l>1, is derived by aggregating transformed features of neighboring nodes from the previous level l−1 as shown in Eqn. (3).

$${ℱ}_{t}^{( l )} ( {S}_{i} ) = {\sum }_{{S}_{j} ∈ 𝒩 ( {S}_{i} )} {ℱ}_{t}^{( l - 1 )} ( {S}_{j} ) \qquad ( 3 )$$

In Eqn. (3), the feature representation of a node at level l is the sum of the transformed features of its neighboring nodes from the previous level. For each node Sᵢ, the function N identifies a set of neighboring nodes that share similar attributes based on similarity scores. This procedure enhances the comprehensiveness of each node feature set as it ascends through the hierarchical layers.

Message-Passing Mechanism: In the hierarchical design, nodes are interconnected through a message-passing mechanism. The message

$${m}_{t}^{( l )} ( {S}_{i} , {S}_{j} )$$

at level l and time t is influenced by the weight matrix [symbol] and the feature vector

$${F}_{t}^{( l - 1 )} ( {S}_{j} )$$

transmitted from Sⱼ to Sᵢ. The message from node Sⱼ to Sᵢ is represented as in Eqn. (4).

$${m}_{t}^{( l )} ( {S}_{i} , {S}_{j} ) = {w}_{i j}^{( l )} \cdot {F}_{t}^{( l - 1 )} ( {S}_{j} ) \qquad ( 4 )$$

In Eqn. (4), the message is a product of the weight matrix specific to that level and the feature vector of the sending node. The message

$${m}_{t}^{( l )} ( {S}_{i} , {S}_{j} )$$

is transmitted from node Sⱼ to node Sᵢ shaped by the dimensions of the weight matrix [symbol] and the feature vector

$${F}_{t}^{( l - 1 )} ( {S}_{j} ) .$$

The weight matrix [symbol] , of importance at level l, typically has a shape of (Dₗ×Dₗ₋₁), where Dₗ denotes the feature dimension at level land Dₗ₋₁ represents the dimension at the preceding level l−1. Simultaneously, the feature vector of the node Sⱼ from the previous layer, denoted as

$${F}_{t}^{( l - 1 )} ( {S}_{j} ) ,$$

is represented as a column vector with dimensions of (Dₗ₋₁×1).

Hierarchical Aggregation: As the HIG model traverses its hierarchical structure, it progressively aggregates and refines node features from the initial to the final level. This transition involves combining and transforming node features, ensuring that the intricate details captured at lower levels are seamlessly integrated into the higher-level context. The process culminates at the highest level L, where the model consolidates all the refined features into a single graph cell at t=1, as represented in Eqn. (5).

$${ℱ}_{l}^{( L )} ( {S}_{i} ) = {\sum }_{{S}_{j} ∈ 𝒩 ( {S}_{i} )} {ℱ}_{l}^{( L - 1 )} ( {S}_{j} ) \qquad ( 5 )$$

Eqn. (5) indicates the final feature representation

$${ℱ}_{l}^{( L )} ( {S}_{i} )$$

at level L is an aggregation of the transformed features of its neighboring nodes from the previous level. This final representation encapsulates the comprehensive interactivity information from all hierarchical levels.

Interactivity Prediction: For every pair of nodes (Sᵢ,Sⱼ), the function [symbol] is employed to analyze their interactivity. This function considers both the message

$${m}_{l}^{( L )} ( {S}_{i} , {S}_{j} ) ,$$

which encapsulates the interactivity between the nodes, and the feature representation w which

$${ℱ}_{l}^{( L )} ( {S}_{i} ) ,$$

reflects the features of the node Sᵢ at the highest hierarchical level. The prediction function is formulated as in Eqn. (6).

$$I ( {S}_{i} , {S}_{j} ) = 𝒸 ( {m}_{l}^{( L )} ( {s}_{i} , {s}_{j} ) , {ℱ}_{l}^{( L )} ( {S}_{i} ) ) \qquad ( 6 )$$

In Eqn. (6), I(Sᵢ, Sⱼ) represents the predicted interactivities between nodes Sᵢ and Sⱼ. The classification function [symbol] operates on the features and messages at the highest hierarchical level to produce a fine-grained classification on the edge connecting these nodes. The output of this function is represented in the set I, where each element provides a detailed classification of the five interactivity types, including appearance ( [symbol] ), situation ( [symbol] ), position ( [symbol] ), interaction ( [symbol] ), and relation ( [symbol] ).

Designing a framework as the HIG model, involving data with varying subjects has distinct advantages. First, graphs are well-suited for the task, where the number of subjects can vary. Second, the message-passing mechanism allows interactivities to be exchanged between neighboring nodes. Finally, HIG allows for a contextual understanding of where and when information occurs in the video, which is essential for tasks that require precise timestamps of events or actions.

Training Loss. The HIG model employs an integral training loss utilizing hierarchical weight sharing and sequential unfreezing techniques, with details provided in the following section.

Sequential Training Strategy. The HIG framework employs a hierarchical weight-sharing strategy to enhance the efficiency of the training process. By sharing weights across different levels of the GNN hierarchy, the model takes advantage of a reduction in the total number of parameters, which operates as a regularizing mechanism to improve model generalization. In particular, training within the HIG framework is conducted through a sequential unfreezing strategy. Initially, the base level is activated, and subsequent levels are progressively unfrozen. This strategy allows the network to adapt to the feature embeddings

$${ℱ}_{t}^{( L )} ( {S}_{i} ) ,$$

which are refined at each level l and time step t.

At each level, the Focal Loss function is employed for edge classification as in Eqn. (7).

$$ℒ ( {ℱ}_{t}^{( l )} ( {S}_{i} ) ) = - {{α}_{t} ( 1 - {p}_{t} ( {ℱ}_{t}^{( l )} ( {S}_{i} ) ) )}^{γ} log ( {p}_{t} ( {ℱ}_{t}^{( l )} ( {S}_{i} ) ) ) \qquad ( 7 )$$

where pₜ measures the probability for the class, αₜ is a weighting factor, and γ is a parameter that adjusts the rate.

Loss Aggregation: The losses computed at each hierarchical level are aggregated to determine the total loss for the model as in Eqn. (8). This aggregation ensures that the training signal is comprehensive and encapsulates the learning objectives at each hierarchy level. The HIG framework promotes a nuanced training process, empowering the GNN to model the inherent hierarchical structures.

$${ℒ}_{total} = {\sum }_{l} ℒ ( {ℱ}_{t}^{( l )} ( {S}_{i} ) ) \qquad ( 8 )$$

### Example 1.6. Experiment Results

Implementation Details. Dataset: The training set comprises 55K subjects and 197K interactivities across 500 videos. The validation set, which is used as the test set, comprises 988 videos with 113K subjects and 400 interactivities. In addition, Applicant uses PSG to evaluate the performance on the image data.

Model Configurations: This Example uses the PyTorch framework and operates on 8×NVIDIA RTX A6000 GPUs. It utilizes a training batch size of 1 and employs the AdamW Optimizer, starting with an initial learning rate of 0.0001. Applicant employs PyTorch Geometric for constructing graphs where nodes represent detections and edges signify potential interactivities. It integrates a ResNet-50 backbone trained with DETR. The framework involves edge pruning using scatter_min and scatter_max for aggregating node features such as bounding box coordinates and track identification. Then, the framework calculates cosine similarity and selects the top-k (k=12) nearest neighbors.

Metrics: Applicant calculates the recall metric for the Visual Interactivity Understanding task to predict a set of triplets that accurately describe the input video. The model predicts the category labels for the subject, object, and predicate within each triplet. Each triplet represents a distinct interactivity in the range time t₁ and t₂. Moreover, each triplet corresponds to a specific subject in single-actor scenarios and a pair of subjects in double-actor scenarios based on a predefined set. To this end, Applicant leverages the standard metrics used in activity understanding, including R@K and mR@K utilized to evaluate the recall of top K categories and their mean recall, respectively.

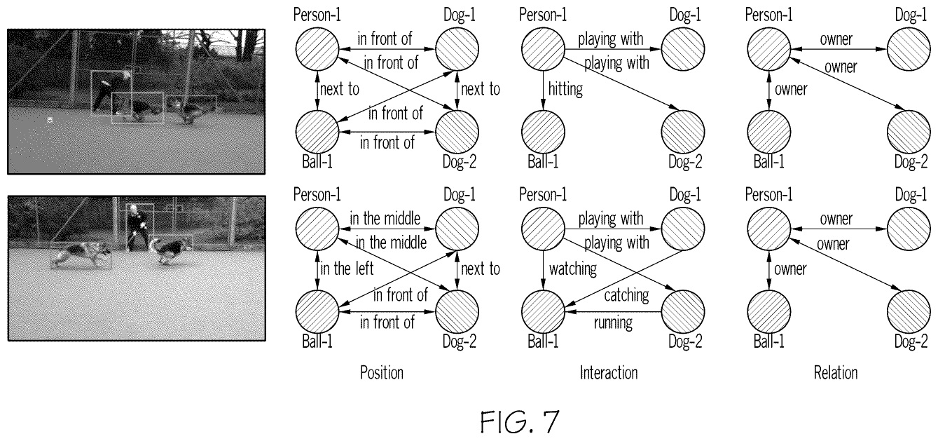

Ablation Study. Baseline Methods: Applicant re-implemented four baseline methods presented in Table 2 and Table 4 since the official implementation is unavailable. Table 2 compares all baseline methods and the HIG along single-actor attributes, and Table 4 compares double-actor attributes. HIG is designed to analyze videos through a hierarchical structure that progressively accumulates temporal information across multiple levels. Instead of getting results for each frame separately, as is done at level l=1, Applicant prefers the predictions made at higher levels, where the confidence score is greater (≥0.9). A higher hierarchy level covers a more significant portion of the video frame, as in FIG. 6. This approach effectively reduces noise and produces a higher recall rate. In particular, the HIG method is better at recognizing single-actor attributes than other baselines, including Transformer, Convolution, Handcrafted, and Vanilla. Specifically, the HIG model is 2.67% higher than the Transformer, the best method in baseline at R@20. HIG is also better for the double-actor attributes, especially in figuring out interactions and relations. It is 1.34% higher than Transformers at R@20 when identifying interactions. Applicant visualizes keyframe predictions in a video, as shown in FIG. 7.

TABLE 2
Comparison against baseline methods on single-actor attributes.

| Method | Interlacement | R/mR@20 | R/mR@50 | R/mR@100 |
|---|---|---|---|---|
| Vanilla | Appearance | 10.88/0.09 | 12.19/0.09 | 14.16/0.08 |
| | Situation | 2.87/0.02 | 5.29/0.03 | 9.05/0.03 |
| Handcrafted | Appearance | 11.09/0.11 | 12.26/0.13 | 14.27/0.17 |
| | Situation | 3.08/0.04 | 5.36/0.07 | 9.16/0.12 |
| Convolution | Appearance | 11.32/0.11 | 12.28/0.25 | 14.32/0.22 |
| | Situation | 3.31/0.04 | 5.38/0.19 | 9.21/0.17 |
| Transformer | Appearance | 12.35/0.62 | 13.89/0.64 | 16.10/0.66 |
| | Situation | 4.54/0.55 | 6.99/0.58 | 10.99/0.61 |
| HIG | Appearance | 15.02/0.60 | 18.60/0.64 | 20.11/0.65 |
| | Situation | 5.01/0.56 | 7.02/0.55 | 12.01/0.63 |

TABLE 3
Comparison against previous methods on ASPIRe.

| Method | Interlacement | R/mR@20 | R/mR@50 | R/mR@100 |
|---|---|---|---|---|
| IMP | Position | 9.70/0.49 | 9.70/0.49 | 9.70/0.49 |
| | Interaction | 12.79/0.08 | 12.79/0.08 | 12.79/0.08 |
| | Relation | 11.51/0.32 | 11.51/0.32 | 11.51/0.32 |
| MOTIFS | Position | 6.89/0.48 | 8.49/0.38 | 8.70/0.40 |
| | Interaction | 8.83/0.12 | 10.33/0.12 | 10.57/0.12 |
| | Relation | 8.72/0.32 | 10.26/0.32 | 10.55/0.32 |
| VCTree | Position | 4.18/0.39 | 6.75/0.40 | 8.59/0.42 |
| | Interaction | 6.23/0.10 | 9.58/0.10 | 11.63/0.10 |
| | Relation | 6.51/0.27 | 9.82/0.28 | 11.51/0.28 |
| GPSNet | Position | 12.89/1.26 | 12.89/1.26 | 12.89/1.26 |
| | Interaction | 10.89/0.11 | 10.89/0.12 | 10.89/0.12 |
| | Relation | 9.87/0.35 | 9.87/0.35 | 9.87/0.35 |
| HIG | Position | 13.02/0.09 | 24.52/1.33 | 42.33/1.12 |
| | Interaction | 12.02/0.11 | 24.65/0.12 | 41.65/0.14 |
| | Relation | 10.26/0.29 | 23.72/0.34 | 41.47/0.39 |

TABLE 4
Comparison against baseline methods on double-actor attributes.

| Method | Interlacement | R/mR@20 | R/mR@50 | R/mR@100 |
|---|---|---|---|---|
| Vanilla | Position | 10.52/0.50 | 21.97/0.55 | 38.05/0.62 |
| | Interaction | 10.16/0.12 | 22.35/0.13 | 39.91/0.14 |
| | Relation | 9.71/0.32 | 21.96/0.36 | 39.11/0.40 |
| Handcrafted | Position | 10.73/0.52 | 22.04/0.59 | 38.16/0.71 |
| | Interaction | 10.37/0.14 | 22.42/0.17 | 40.02/0.23 |
| | Relation | 9.92/0.34 | 22.03/0.40 | 39.22/0.49 |
| Convolution | Position | 10.96/0.52 | 22.06/0.71 | 38.21/0.76 |
| | Interaction | 10.60/0.14 | 22.44/0.29 | 40.07/0.28 |
| | Relation | 10.15/0.34 | 22.05/0.52 | 39.27/0.54 |
| Transformer | Position | 11.04/0.83 | 22.52/0.90 | 38.84/1.02 |
| | Interaction | 10.68/0.45 | 22.90/0.48 | 40.70/0.52 |
| | Relation | 10.23/0.65 | 22.51/0.71 | 39.90/0.96 |
| HIG | Position | 13.02/0.09 | 24.52/1.33 | 42.33/1.12 |
| | Interaction | 12.02/0.11 | 24.65/0.12 | 41.65/0.14 |
| | Relation | 10.26/0.29 | 23.72/0.34 | 41.47/0.39 |

TABLE 5
Comparison at different video sampling rates of the HIG.

| Sampling | | | | | |
|---|---|---|---|---|---|
| Rate | Interlacement | R/mR@20 | R/mR@50 | R/mR@100 | FPS |
| 2 (Half) | Appearance | 12.13/0.59 | 12.25/0.63 | 7.48/0.64 | 26.4 |
| | Situation | 2.12/0.55 | 5.67/0.54 | 8.62/0.62 | |
| | Position | 10.13/0.08 | 18.17/1.32 | 29.7/1.11 | |
| | Interaction | 9.13/0.10 | 18.30/0.11 | 29.02/0.13 | |
| | Relation | 7.37/0.28 | 17.37/0.33 | 28.84/0.38 | |
| 1 (Fall) | Appearance | 15.02/0.60 | 18.60/0.64 | 20.11/0.65 | 24.2 |
| | Situation | 5.01/0.56 | 7.02/0.55 | 12.01/0.63 | |
| | Position | 13.02/0.09 | 24.52/1.33 | 42.33/1.12 | |
| | Interaction | 12.02/0.11 | 24.65/0.12 | 41.65/0.14 | |
| | Relation | 10.26/0.29 | 23.72/0.34 | 41.47/0.39 | |

Video Sampling Rates: Table 5 explores the influence of frame sampling rates on the performance of the HIG model in deployment. The analysis focuses on evaluating the performance under a reduced number of frames. In the AS-PIRe dataset, the testing set includes 988 videos, totaling 10,456,48 frames. Applicant addresses the efficiency of the HIG model by halving the number of frames in each video. In particular, Applicant discarded one frame out of every two successive frames. The experiment reveals a trade-off between recall score and inference time, where the HIG model experiences a decrease in recall performance but achieves a 2.2 FPS increase in inference speed.

TABLE 6
Comparison against previous methods on SGG task.

| Method | Interlacement | R/mR@20 | R/mR@50 | R/mR@100 |
|---|---|---|---|---|
| IMP | Position | 0.25/0.36 | 0.29/0.35 | 0.30/0.33 |
| | Interaction | 0.71/0.13 | 0.98/0.12 | 1.15/0.13 |
| | Relation | 0.80/0.26 | 0.81/0.25 | 0.84/0.24 |
| MOTIFS | Position | 0.23/0.43 | 0.23/0.43 | 0.31/0.38 |
| | Interaction | 0.39/0.11 | 0.94/0.11 | 1.17/0.10 |
| | Relation | 0.31/0.30 | 0.32/0.28 | 0.53/0.32 |
| VCTree | Position | 0.13/0.23 | 0.14/0.22 | 0.14/0.21 |
| | Interaction | 0.55/0.07 | 0.65/0.08 | 0.72/0.08 |
| | Relation | 0.39/0.18 | 0.39/0.20 | 0.43/0.21 |
| GPSNet | Position | 0.09/0.46 | 1.17/0.37 | 1.32/0.46 |
| | Interaction | 0.99/0.09 | 1.02/0.09 | 1.11/0.09 |
| | Relation | 0.14/0.23 | 0.16/0.13 | 0.29/0.23 |
| HIG | Position | 1.00/0.42 | 2.40/0.44 | 4.87/0.47 |
| | Interaction | 1.30/0.09 | 3.45/0.11 | 6.93/0.12 |
| | Relation | 1.26/0.27 | 3.43/0.30 | 7.02/0.32 |

Comparison with State-of-the-Arts. Performance on ASPIRe Applicant provides the comparative analysis with SOTAs in Table 3, including IMP, MO-TIS, VCTree, and GPSNet. In the ASPIRe dataset, the a HIG method shows impressive results in identifying the position on recall at different top K. In addition, the HG model performs well on identifying relations when it is higher than 1.13% at R@20 compared to GPSNet.

Scene Graph Generation (SGG): Applicant extended the capability of the HIG model while incorporating image-based scene graph generation into the training process presented in Table 6. Since the prior method was designed for interactions between pairs of subjects, Applicant focuses the comparison on the double-actor attributes. The HIG method demonstrates superior performance across all interlacement highlighting its advanced proficiency in attribute recognition within frame-based scene graph generation scenarios. Compared to the best-performing previous method, GPSNet, the HIG model achieves improvements of 3.55%, 5.82%, and 6.73% at R@100 for position, interaction, and relation.

Performance on PSG: In addition to evaluating the method on a video dataset, Applicant demonstrated its effectiveness on an image dataset by comparing it with state-of-the-art methods on the PSG dataset, as presented in Table 7. When applied to the PSG dataset, the HIG model treats each image as a single-frame video, shifting its focus to spatial interactivity rather than temporal interactivity. Although the model is primarily designed for video datasets, it achieves comparable results on the image dataset, with only a slight decrease at R@20 compared to state-of-the-art methods. Notably, the HIG model outperforms VCTree by 3.8% in terms of R@100, highlighting the strength of the graph representation.

TABLE 7
Comparison against previous methods on PSG.

| Method | R/mR@20 | R/mR@50 | R/mR@100 |
|---|---|---|---|
| IMP | 16.5/6.52 | 18.2/7.05 | 18.6/7.23 |
| MOTIFS | 20.0/9.10 | 21.7/9.57 | 22.0/9.69 |
| VCTree | 20.6/9.70 | 22.1/10.2 | 22.5/10.2 |
| GPSNet | 17.8/7.03 | 19.6/7.49 | 20.1/7.67 |
| PSGFormer | 18.6/16.7 | 20.4/19.3 | 20.7/19.7 |
| HIG | 19.4/6.42 | 22.3/8.13 | 26.3/9.70 |

### Example 1.7. Conclusion

Applicant addressed the Visual Interactivity Understanding problem by introducing the ASPIRe dataset and the Hierarchical Interlacement Graph. APSIRe established a new benchmark with its extensive predicate types offering nuanced interactivity perspectives. Meanwhile, HIG provides a unified hierarchical structure for capturing complex video interlacements, demonstrating scalability and flexibility in handling five interactivity types. Additionally, Applicant provided extensive experiments showcasing the efficiency of HIG and achieving state-of-the-art results in both video and image datasets.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A method of evaluating dynamic interactions of a video, the method comprising:
receiving a video comprising a plurality of clips;
deconstructing each clip of the plurality of clips into a graph comprising a plurality of nodes and a plurality of edges,
wherein each node of the plurality of nodes in the graph represents a subject or an object, and
wherein each edge of the plurality of edges in the graph represents an interactivity between two nodes; and
tracking changes in node-node interactivities in different clips to evaluate the dynamic interactions of the video.

2. The method of claim 1, wherein the interactivities comprise single-actor attributes of subjects, double-actor attributes of subjects, subject-subject interactions, subject-object interactions, object-object interactions, or combinations thereof.

3. The method of claim 1, wherein the interactivities comprise single-actor attributes of subjects.

4. The method of claim 3, wherein the single-actor attributes comprise appearance, situation, or combinations thereof.

5. The method of claim 1, wherein the interactivities comprise double-actor attributes of subjects.

6. The method of claim 5, wherein the double-actor attributes comprise position, interaction, relationship, or combinations thereof.

7. The method of claim 1, wherein the tracking changes in node-node interactivities comprises dynamically updating each node's feature vector based on neighboring node attributes.

8. The method of claim 7, further comprising a step of aggregating feature vectors from lower-level graphs to form higher-level representations.

9. The method of claim 8, wherein the higher-level representations encapsulate the full spectrum of interactivity within the video.

10. A system for evaluating dynamic interactions of a video, comprising:
memory; and
at least one processor coupled to the memory and configured to implement a method, the method comprising:
receiving a video comprising a plurality of clips;
deconstructing each clip of the plurality of clips into a graph comprising a plurality of nodes and a plurality of edges,
wherein each node of the plurality of nodes in the graph represents a subject or an object, and
wherein each edge of the plurality of edges in the graph represents an interactivity between two nodes; and
tracking changes in node-node interactivities in different clips to evaluate the dynamic interactions of the video.

11. The system of claim 10, wherein the interactivities comprise single-actor attributes of subjects, double-actor attributes of subjects, subject-subject interactions, subject-object interactions, object-object interactions, or combinations thereof.

12. The system of claim 10, wherein the interactivities comprise single-actor attributes of subjects.

13. The system of claim 12, wherein the single-actor attributes comprise appearance, situation, or combinations thereof.

14. The system of claim 10, wherein the interactivities comprise double-actor attributes of subjects.

15. The system of claim 14, wherein the double-actor attributes comprise position, interaction, relationship, or combinations thereof.

16. The system of claim 10, wherein the tracking changes in node-node interactivities comprises dynamically updating each node's feature vector based on neighboring node attributes.

17. The system of claim 16, further comprising a step of aggregating feature vectors from lower-level graphs to form higher-level representations.

18. The system of claim 17, wherein the higher-level representations encapsulate the full spectrum of interactivity within the video.

19. A computer-program product comprising a non-transitory computer-usable medium having computer-readable program code embodied therein, the computer-readable program code adapted to be executed to implement a method for evaluating dynamic interactions of a video comprising:
receiving a video comprising a plurality of clips;
deconstructing each clip of the plurality of clips into a graph comprising a plurality of nodes and a plurality of edges,
wherein each node of the plurality of nodes in the graph represents a subject or an object, and
wherein each edge of the plurality of edges in the graph represents an interactivity between two nodes; and
tracking changes in node-node interactivities in different clips to evaluate the dynamic interactions of the video.

20. The computer-program product of claim 19, wherein:
the tracking changes in node-node interactivities comprises dynamically updating each node's feature vector based on neighboring node attributes;
the method, further comprises a step of aggregating feature vectors from lower-level graphs to form higher-level representations; and
the higher-level representations encapsulate the full spectrum of interactivity within the video.
